(19) United States
(12) Patent Application Publication
(10) Pub. No.: US 2003/0117650 A1
(43) Pub. Date: Jun. 26, 2003

(54) Information processing device for assigning instruction information to processing subject information and method thereof

(76) Inventor: Masanori Wakai, Kanagawa (JP)

Correspondence Address: MORGAN & FINNEGAN, L.L.P., 345 PARK AVENUE, NEW YORK, NY, 10154, US

(21) Appl. No.: 10/328,320

(22) Filed: Dec. 23, 2002

(30) Foreign Application Priority Data
Dec. 25, 2001 (JP) 2001-391777
Dec. 25, 2001 (JP) 2001-391778

(51) Int. Cl. B41J 1/00; G06F 15/00

(52) U.S. Cl. 358/1.15

(57) ABSTRACT

An information processing device assigns instruction information showing a process that should be executed to a print subject information, and transmits the print subject information assigned the instruction information to a print device. The print device receives the print subject information, retrieves the instruction information from the print subject information received, and executes a process corresponding to the retrieved instruction information upon the print subject information received.

### BACKGROUND OF THE INVENTION

1. Field of the Invention

The present invention relates to an information processing device for processing information in accordance with an instruction given from a user, and to a method thereof.

2. Related Background Art

FIG. 18 is an explanatory view showing the prior art.

A user must take the following steps in order to attain some purpose.

1. Think of a purpose.

2. Think of what process a machine should be made to execute in order to the above purpose.

3. Perform an operation corresponding to the purpose and assign an instruction to the machine in order to execute the above process.

4. Transfer subject data if there arises a necessity of executing the process by use of other machine for some reason.

5. Install beforehand the process into the machine if not preinstalled.

6. Assign the instruction to the machine by performing a corresponding operation for making the machine execute the process give above.

For example, if there occurs a situation where the user must convey something to somebody, the information the user desires to convey might be printed and thus transferred. This process is, if applied to the steps given above, analyzed as follows:

1. Think of a purpose “transfer the information to Mr. A”.

2. The user becomes aware that the information must be converted into a humanly-operable physical format such as being visually or audibly perceived in order to transfer the information, and thinks of commanding the machine to execute a process “print the information”.

3. The user boots an application corresponding to the print process and assigns a print instruction by performing the print operation.

4. The print cannot be effected due to a trouble of the operating machine, and hence a file to be printed is transferred to other machine.

5. A printer driver is not installed into the transfer destination machine, and therefore a program necessary for installing it is obtained, and the installation is carried out.

6. The operation in the step 3 is conducted in steps matching with the transfer destination machine.

There are the following problems inherent in the prior art described above.

Problem 1: In the case of printing a great quantity of documents and using a low-speed route such as a telephone line and so on, there increases a time of the data transfer conducted in step 4.

Problem 2: When or after transferring the data in step 4, a problem in terms of security might arise, wherein the data are wiretapped or falsified by a third party.

Problem 3: The installation in step 5 requires technical knowledge of the user and must start with preparing an environment (platform) needed for the installation itself.

Problem 4: If the instruction from the user in step 6 is, though a load given onto the user can be minimized if absolutely the same type of machines are utilized, hard to be operated by the user simply when a language used for UI (User Interface) is different, for example, although the process itself is the same.

Problem 5: The determination of the process corresponding to the purpose in step 2 requires some experience of the user and, even if a plurality of options can be thought of, only one of these processes can be determined at one time.

### SUMMARY OF THE INVENTION

Accordingly, it is a primary object of the present invention to provide an information processing device and an information processing method that are capable of remarkably reducing a load on a user by eliminating a necessity of re-assigning an instruction in a case where other device is made to execute a process instructed to a certain device.

According to one aspect, the present invention which achieves these objectives relates to an information processing device comprising, instruction information assigning means for assigning instruction information showing a process that should be executed, to process subject information, transmitting means for transmitting the process subject information assigned the instruction information, receiving means for receiving the process subject information, instruction information retrieving means for retrieving the instruction information from the processing subject information received, and process executing means for executing a process corresponding to the retrieved instruction information upon the processing subject information received.

According to another aspect, the present invention which achieves these objectives relates to an information processing device comprising purpose information assigning means for assigning purpose information showing a purpose of a process to processing subject information, transmitting means for transmitting the processing subject information assigned the purpose information, receiving means for receiving the processing subject information, purpose information retrieving means for retrieving the purpose information from the processing subject information received, and process executing means for executing a process corresponding to the retrieved purpose information upon the processing subject information received.

According to still another aspect, the present invention which achieves these objectives relates to an information processing method executed by a first device and a second device, comprising the steps of assigning instruction information showing a process that should be executed to processing subject information by the first device, transmitting the processing subject information assigned the instruction information to the second device by the first device, receiving the processing subject information by the second device, retrieving the instruction information from the received processing subject information by the second device, and executing the process corresponding to the retrieved instruction information upon the received processing subject information by the second device.

According to yet another aspect, the present invention which achieves these objectives relates to an information processing method executed by a first device and a second device, comprising the steps of assigning purpose information showing a purpose of a process to processing subject information by the first device, transmitting the processing subject information assigned the purpose information to the second device by the first device, receiving the processing subject information by the second device, retrieving the purpose information from the received processing subject information by the second device, and executing a process corresponding to the retrieved purpose information upon the received processing subject information by the second device.

Other objectives and advantages besides those discussed above shall be apparent to those skilled in the art from the description of preferred embodiments of the invention which follow. In the description, reference is made to accompanying drawings, which form a part thereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a block diagram showing an architecture of an information processing system in one embodiment;

FIG. 2 is a block diagram showing a an architecture of an information processing device in one embodiment;

FIG. 3 is a block diagram showing an architecture of a print processing device in one embodiment;

FIG. 4 is a diagram showing a language structure of a print control language;

FIG. 5 is a diagram showing an example of a program of the print control language;

FIG. 6 is a diagram showing a result of printing based on the program of the print control language;

FIG. 7 is a diagram showing, as data structures, characteristic portions of the program for designating beforehand a combination of code processing means capable of performing the most effective compression and development;

FIG. 8 is a flowchart showing the characteristic portion of the program for designating beforehand the combination of the code processing means capable of performing the most effective compression and development;

FIG. 9 is a diagram showing an example of the program of the print control language;

FIG. 10 is a diagram showing an example of the program of the print control language;

FIG. 11 is a flowchart showing the characteristic portion of the program for compressing code information assigned;

FIG. 12 is a flowchart showing the characteristic portion of the program for developing the code information;

FIG. 13 is a view showing the prior art;

FIG. 14 is a view showing the present embodiment;

FIG. 15 is a flowchart showing the characteristic portion in a print information creating means;

FIG. 16 is a flowchart showing the characteristic portion in a print information management means;

FIG. 17 is a flowchart showing the characteristic portion with respect to a failure process in the print information management means;

FIG. 18 is a diagram showing one example of steps executed for a user to attain some purpose;

FIG. 19 is a diagram showing one example of steps executed for the user to attain some purpose in an embodiment 1;

FIG. 20 is a diagram showing one example of the steps executed for the user to attain some purpose in an embodiment 2;

FIG. 21 is a diagram showing one example of the steps executed for the user to attain some purpose in an embodiment 3;

FIG. 22 is a diagram showing one example of the steps executed for the user to attain some purpose in embodiments 4 and 5;

FIG. 23 is a block diagram showing a hardware architecture of the information processing device;

FIG. 24 is a flowchart showing processing steps of the whole system;

FIG. 25 is a diagram showing one example of a user's operation of designating a processing subject and a type of instruction;

FIG. 26 is a flowchart showing steps of an instruction information assignment process;

FIG. 27 is a diagram showing one example of a corresponding process definition table that is referred to in the instruction information assignment process;

FIG. 28 is a flowchart showing steps of an instruction information retrieving process in the embodiment;

FIG. 29 is a flowchart showing steps of an instruction corresponding process in the embodiment;

FIG. 30 is a flowchart showing processing steps of the whole system in the embodiment;

FIG. 31 is a diagram showing one example of a user's operation of designating the processing subject and a purpose;

FIG. 32 is a flowchart showing steps of a purpose information assignment process;

FIG. 33 is a diagram showing one example of a corresponding purpose definition table;

FIG. 34 is a diagram showing one example of a purpose corresponding instruction definition table;

FIG. 35 is a flowchart showing steps of the purpose information retrieving process;

FIG. 36 is a flowchart showing steps of the purpose corresponding process; and

FIG. 37 is a flowchart showing steps of the purpose corresponding process.

### DESCRIPTION OF THE PREFERRED EMBODIMENTS

Preferred embodiments of the present invention will hereinafter be described in details with reference to the accompanying drawings.

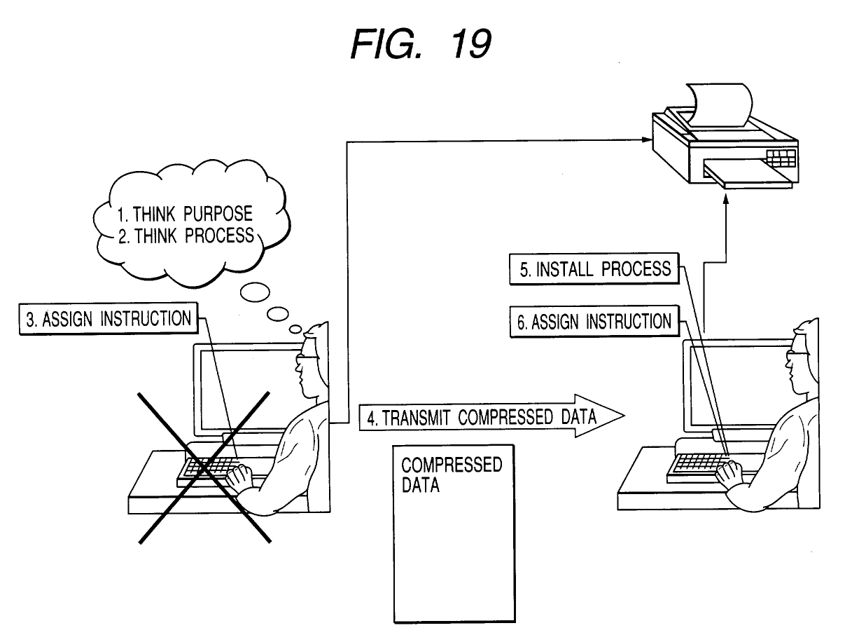

An embodiment 1, which will be discussed later on, puts an emphasis on the problem 1 described above and therefore has a scheme of selectively executing a compression method optimal to a characteristic of data to be transferred as shown in FIG. 19.

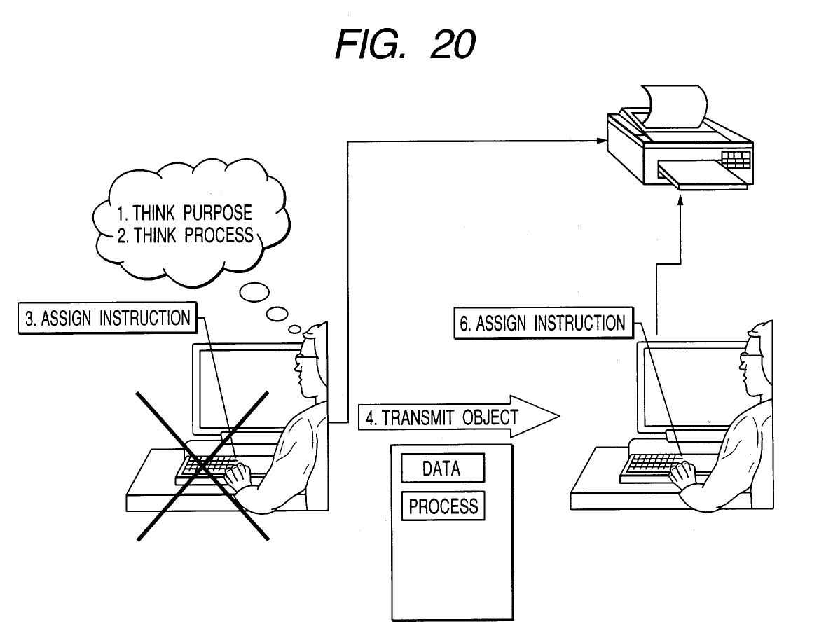

An embodiment 2, which will hereinafter be described, puts the emphasis on the problems 2 and 3 given above and therefore has, as shown in FIG. 20, a scheme of omitting the installation in the problem 3 by dealing with the data and the processes as one set, and also has a scheme of solving the problem 2 in a way that includes the process for actualizing the security.

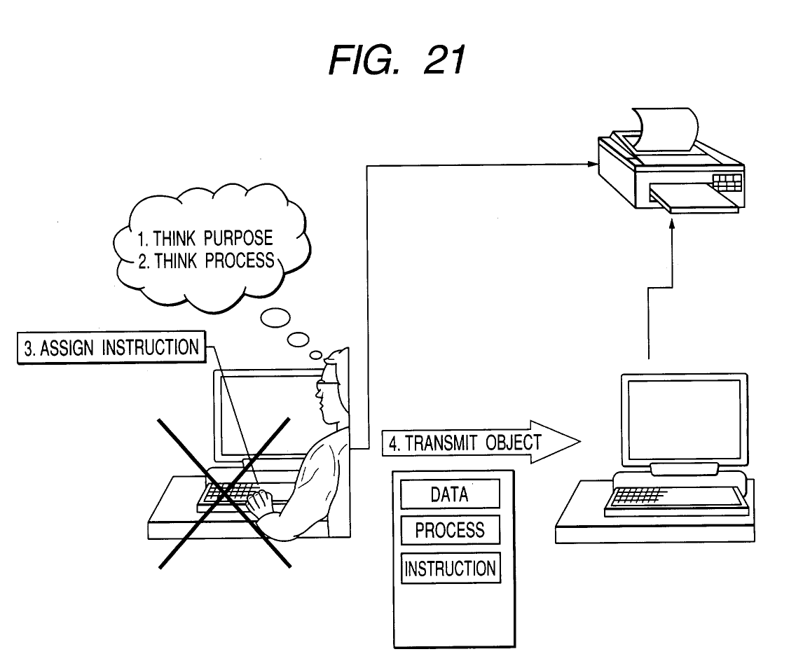

An embodiment 3, which will be hereinafter be explained, puts the emphasis on the problem 4 and therefore has, as shown in FIG. 21, a scheme of eliminating the necessity of giving an instruction again to even a different machine by sealing with the data, the process and the instruction as one set. Further, the embodiment 3 enables any machines to execute the process simply by giving the instruction to a well-accustomed machine.

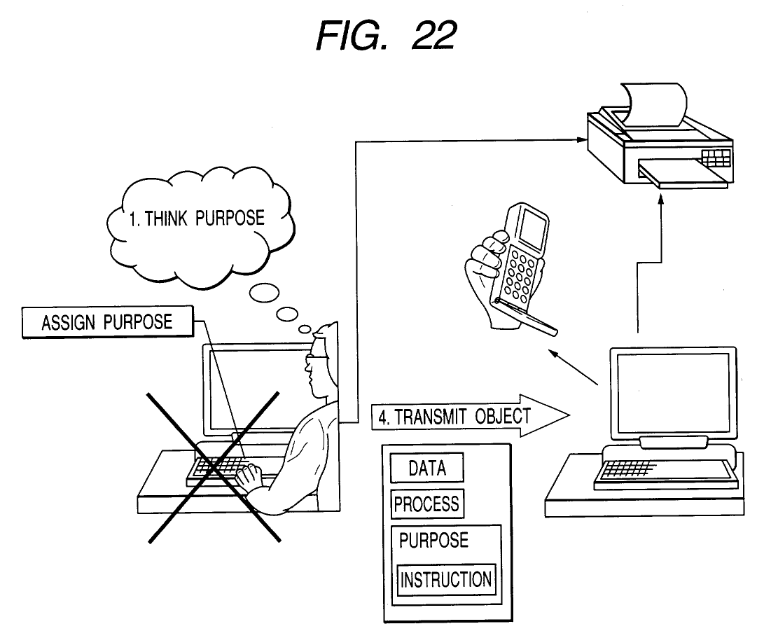

Embodiments 4 and 5, which will be discussed alter on, put the emphasis on the problem 5 described above, and therefore has, as shown in FIG. 22, a scheme of eliminating the necessity of determining a necessary process by dealing with the data, the process (the instruction) and an object as one set, and enables a plurality of options to be separately used.

<Embodiment 1>

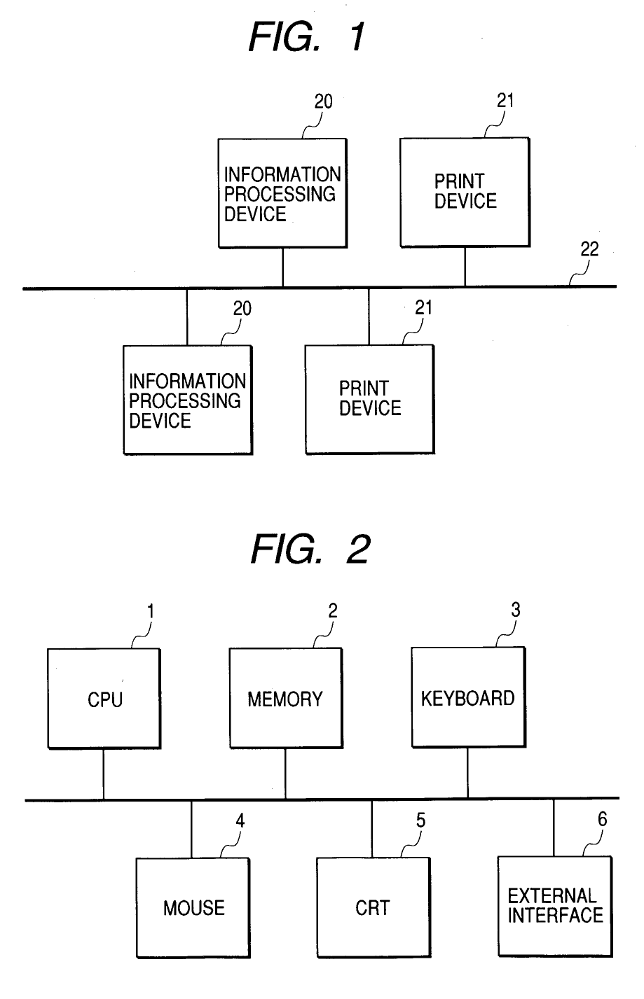

FIG. 1 is a block diagram showing a system architecture in this embodiment. An information processing device 20 and a print device 21 are connected to each other via a device connection medium 22 such as a network etc. FIG. 1 illustrates that a plurality of information processing devices and a plurality of print devices are under the same network environment and are connected to each other. In this case, the information processing device 20 is capable of selecting, based on a judgement of a user or a computer program, and arbitrary print device and executing a print instruction.

FIG. 2 is a block diagram schematically showing a configuration of the information processing device 20 in this embodiment. Referring to FIG. 2, a CPU 1 executes a variety of programs and governs the control of the whole device. A memory 2 is constructed of a ROM, a RAM and a disk device, and is stored with various pieces of data and programs. A keyboard 3 is operated by a user to input text information and commands. A mouse 4 is used as a pointing device and is manipulated to make an input occur. A CRT 5 displays the text information and image information. An external interface 6 connects to an external device such as the print device via a wired medium such as a cable or a wireless medium.

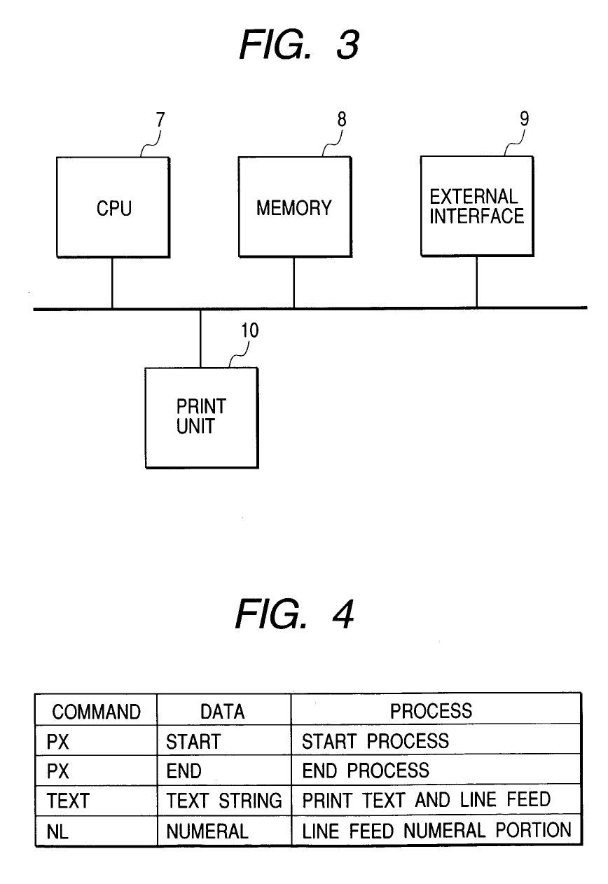

FIG. 3 is a block diagram schematically showing a configuration of the print device in this embodiment. A CPU 7 processes the information sent from the external device by executing a variety of programs, and governs the control of the whole device. A memory 8 is constructed of the ROM, the RAM and the disk device, and is stored with various pieces of data and programs. An external interface 9 connects to an external device such as the information processing device via the wired medium such as the cable or the wireless medium. A print unit 10 performs actual printing on a sheet based on an instruction from the CPU 7.

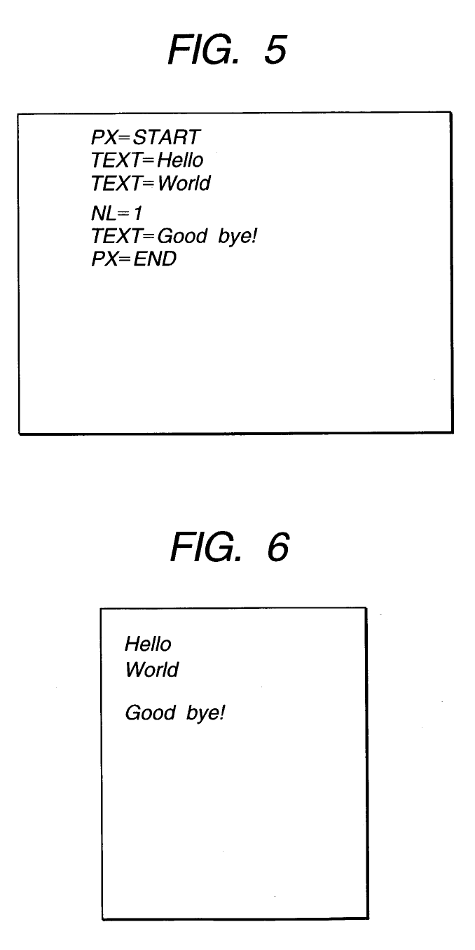

Operations of the information processing device 20 and the print device 21 which have the configurations described above, will hereinafter be discussed in depth. In the following discussion, an assumption is that a unique print control language [PDL-X] be used as a category of subject information. [PDL-X] is defined as a simple print control language for instructing a print to the print device. FIG. 4 shows a language system of [PDL-X]. According to [PDL-X], invariably one line exists in a [command=data] format, and a plurality of lines is aggregated into a unit for showing one print result. For example, a result of the print instruction based on PDL-X described in FIG. 5 becomes as shown in FIG. 6. Herein, for explanation's sake, the simplest [PDL-X] is used by way of an example, however, other print control language aiming at giving the print instruction to the print device are also effective as processing subjects.

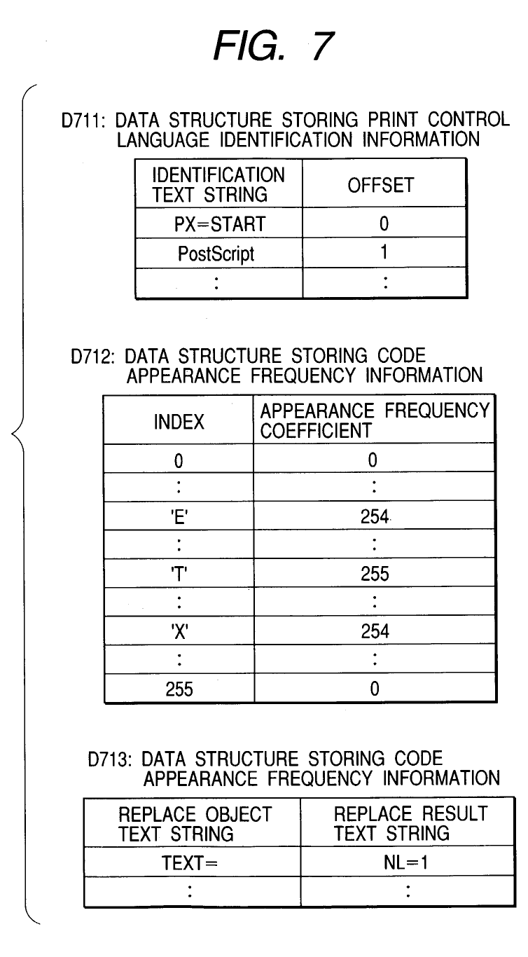

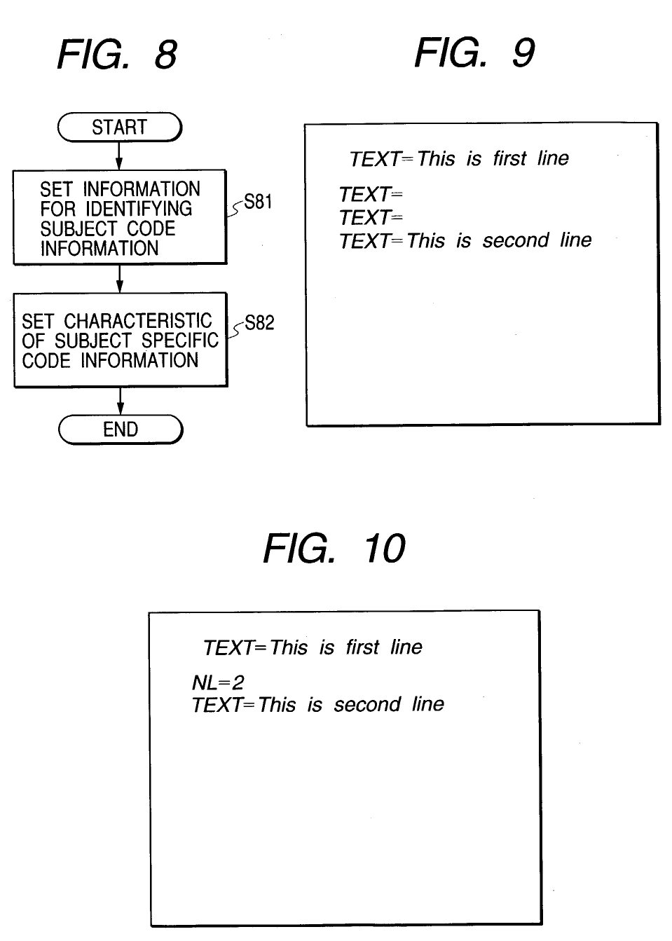

FIGS. 7 and 8 show data structures and a flowchart of a characteristic portion of a program of a compression/development processing method designation mechanism for assigning beforehand a combination of code processes by which the most effective compressing and development can be carried out.

FIG. 7 shows the data structures used in the present program. A data structure D711 contains fields for storing information for identifying a category of the print control language, and consists of information of a text string used for the identification and offset information from a head indicating a position where the text string appears. A data structure D712 is a table showing appearance frequency information of the code information. The appearance frequency is expressed by an 8-bit value in the 8-bit code information. Therefore, the data structure 712 contains 256 pieces of table entries each having an 8-bit width. A data structure D713 is defined as replacement information used for a nonreversible compression of the information. The replacement information consists of a replace object text string and a replace result text string.

FIG. 8 is the flowchart showing the characteristic portion of the compression/development processing method designation program for previously assigning the combination of the code processing means by which the most effective compression and development can be effected with respect to an aggregation of pieces of code information having a specific regularity. In step S81, a piece of information for identifying the subject code information is set. Herein, the print control language [PDL-X] used for the explanation has such a characteristic that all the data start with a command line [PDL-X=START] and end with [PDL-X=END]. Accordingly, herein, when the text string [PDL-X=START] comes to the head, it follows that there is obtained a piece of information indicating that this text string is the code information described in [PDL-X]. From the above-mentioned, in step S81, the field of the text string information used for identifying the data D711 is stored with “PDL-X=START”, and the offset information field is stored with “0” indicating the head.

In step S82, a characteristic of specific code information serving as a subject is set. Namely, there are set conditions under which there occurs a bias in the appearance frequency in the specific text information and a repetition of a specific information pattern. The print control language [PDL-X] used for the discussion herein has a characteristic of exhibiting an extremely high appearance frequency of the [TXT] command showing the text string to be printed. It can be therefore understood that short codes should be assigned to the characters T, E, and X in the process of a code compression. Further, it can be statistically determined without analyzing the actual print information that “T” exhibits the extremely high appearance frequency. Hence, in the table D712, “255” is stored in the entry corresponding to the character “T”, and “254” is stored in the entries corresponding to the characters “E” and “X”.

Further, according to [PDL-X], a command [TEXT=] and a command [NL=1] show an equivalent effect. Namely, both the commands imply that one blank line be printed. Further, according to the [NL] command, if a plurality of blank lines is consecutive, a numerical value indicating the number of blank lines can be described as data. If this characteristic is utilized, and if there exists information described in [PDL-X] as shown in FIG. 9, this generates a print result equivalent to that in FIG. 10. To be more specific, in the case of detecting a pattern containing a plurality of consecutive [TEXT=] lines, it follows that the information can be effectively compressed by replacing this with a command [NL=x]. With this characteristic utilized, a replace object text string in the data D713 is stored with “TEXT =”, and a replace result text string therein is stored with “NL=1”.

The analysis made in steps S81 and S82 may be designated by the user and may also executed by the computer program. All the processes in steps S81 through S82 must be done before the electronic computer transfers the print instruction information to the print device. It does not happen that the process is executed after the print device starts receiving the print instruction information.

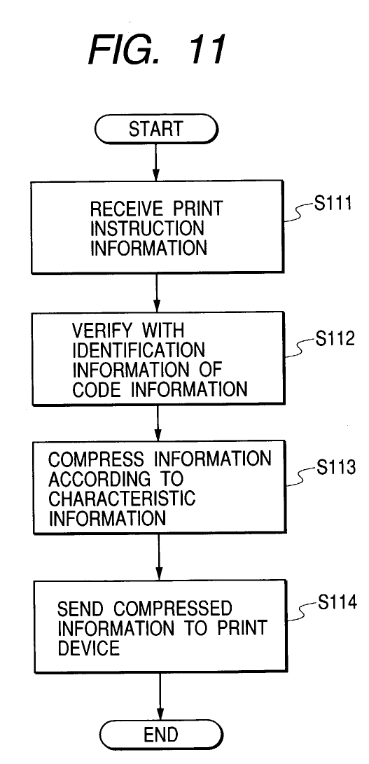

FIG. 11 is a flowchart showing characteristic portions of a process for determining, when the computer sends the print instruction information to the print device, a processing mechanism optimal to compressing and developing an aggregation of code information from among the mechanisms designated by the compression/development processing method designation mechanism in a way that examines the aggregation of the assigned code information, and of a process for compressing and thus transferring the code information.

In step S111, the print instruction information described in the print control language is received from an applied business program and from a print device drive program. In step S112, the information received is collated with the identifying information of the code information that is set in step S81 and saved in step S82. In step S113, the information is compressed based on the characteristic information set in step S81. To start with, it is examined whether the text string is the replace object text string in the data D713 or not, and, if judged to be the replace object text string, this text string is replaced. Next, an arithmetic compression is effected by utilizing the frequency information of the replace object text from within the data D712. In step S114, the compressed information is sent to the print device.

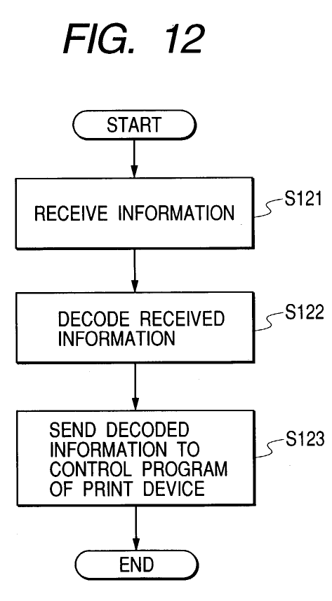

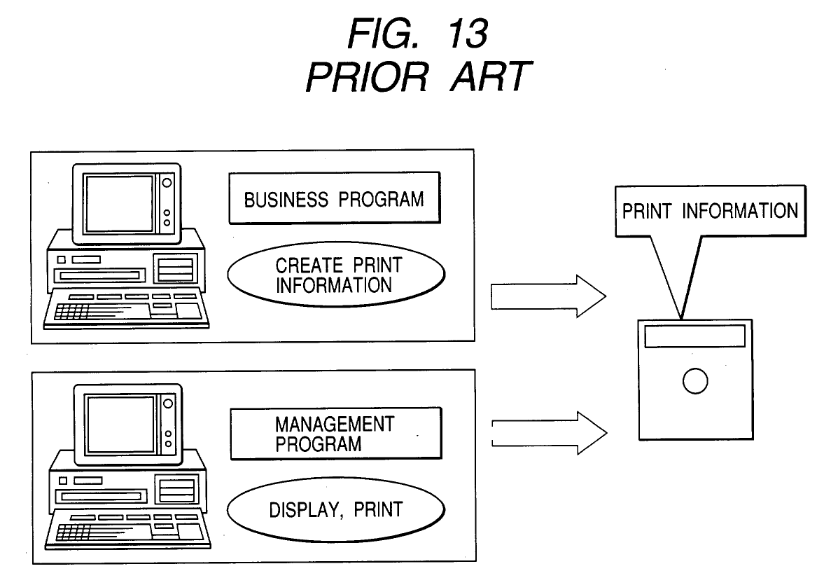

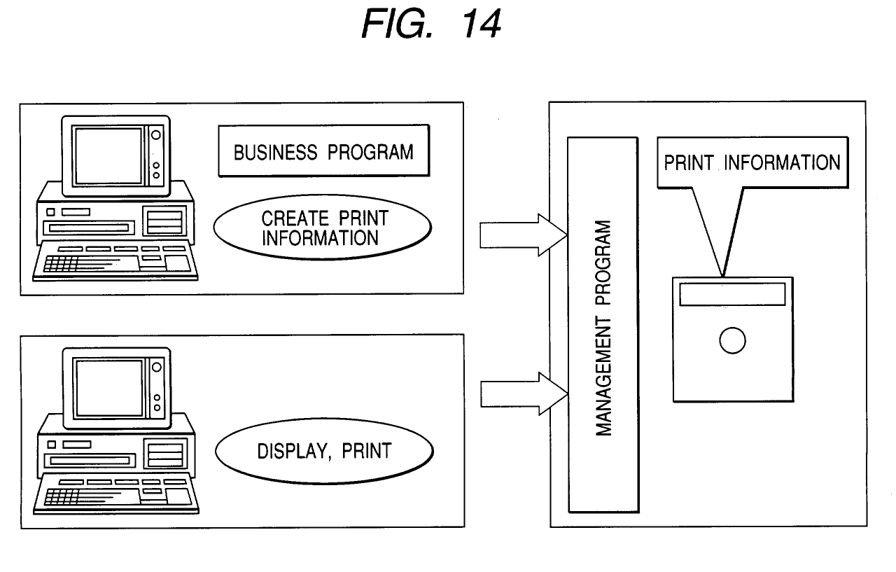

FIG. 12 shows a process for restoring the information compressed based on the method determined by the compression/development processing method determination process and then transferred, in a way that develops the same compressed information. In step S121, the information sent in step S114 is received. In step S122, the information is restored based on the characteristic information set in step S81. At first, the information is decoded by utilizing the frequency information from within the data D712. The information replaced based on D713 has no necessity of being decoded. In step S123, the restored information is transferred to the control program of the actual print device, thereby executing printing.

As discussed above, in this embodiment 1, after analyzing beforehand the characteristics of the information transferred between the information processing devices, the information required for compressing and developing the information is created, the information transfer is then performed, and hence it is possible to yield the more excellent results in terms of a processing speed and an efficiency than by the method of effecting the compression and the development while dynamically analyzing the information characteristics both in a case where the information compression is carried out and in a case where no compression is effected in the same way as the normal compression of the information in the normal communications is done.

<Embodiment 2>

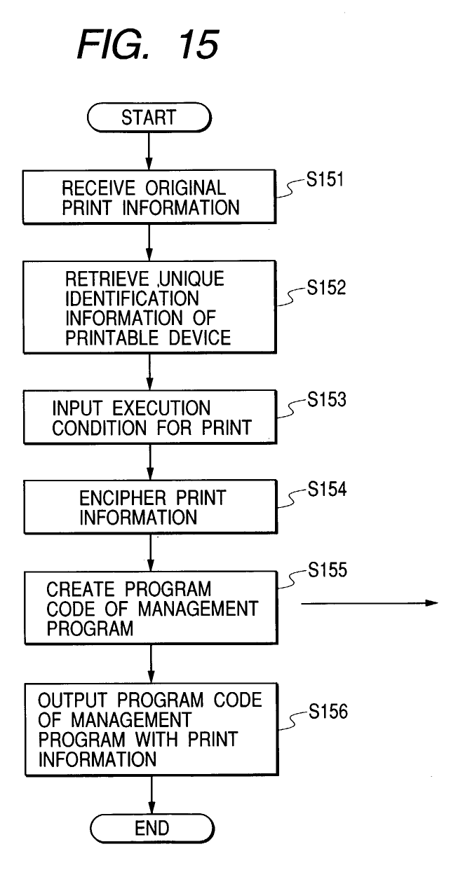

An operation if an embodiment 2 will be discussed in details. The discussion will starts with explaining a print information creation process. FIG. 15 is a flowchart showing a characteristic portion in the print information creation process. In step S151, original print information is received from the applied business program etc. In step S152, a piece of identifying information unique to the device capable of printing the created information, is retrieved. The unique identifying information may be explicitly designated by the user or may be obtained automatically. Further, a designation that the printing is permitted in all the environments, can be made.

In step S153, conditions for executing the printing are inputted. The conditions may be explicitly designated by the user or may also be created automatically. These conditions are exemplified such as being unable to print up to the designated date and time, being unable to print on from the designated date and time, being unable to print if not coincident with the designated password, and so on. In step S154, the print information obtained in step S151 is enciphered by use of values coefficients into which to convert the subject device unique information retrieved in step S152 and the conditions inputted in step S153. With this contrivance, unless these two sets of information are prepared, the print information cannot be decoded. In step S155, program codes of a management program for identifying the conditions inputted in step S153, are created. It is required that the program codes created herein be codes executable by the printable device designated in step S152. In step S156, the print information enciphered in step S154 and the program codes created in step S155, are outputted batchwise.

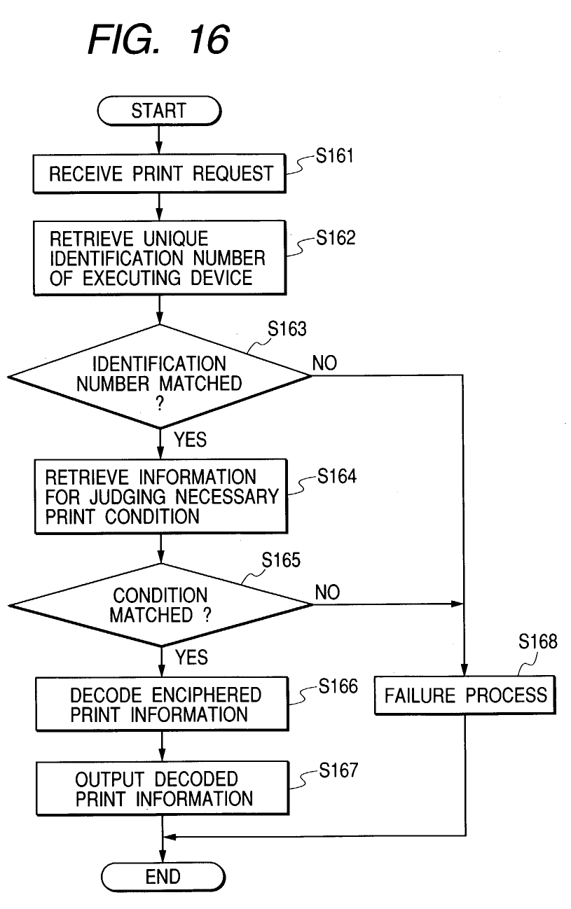

FIG. 16 illustrates a print information management process and is, in the print information creation process, an extraction of a flowchart showing a characteristic portion of the management program created in step S155. In step S161, the management program or an external program receives an input of a print request from the user. In step S162, an identification number of the device in the process of executing is obtained. In step S163, it is checked whether or not the identification number obtained in step S162 is coincident with the information, designated in step in S152, of the print information creation means. If not coincident, the program moves to a failure process in step S168. Whereas if coincident, the information for judging a condition necessary for printing designated in step S153 of the print information creation process, is obtained in step S164. For instance, if the condition designated in step S152 of the print information creation process is as to whether the password is coincident or not, the program prompts the user to input a password. Alternatively, if the condition is that the printing is impossible till the designated date and time are reached, the present date and time are obtained and retained. It is judged in step S165 whether or not the information obtained in step S164 meets the condition designated in step S153 of the print information creation process. If the judgement falls into a failure, the program diverts to the failure process in step S168. If the judgement is successful, in step S166, the is decoded the print information enciphered by using the coefficients into which the device unique identification number obtained in step S162 and the condition information obtained in step S164, are converted. In step S167, the decoded print information is outputted.

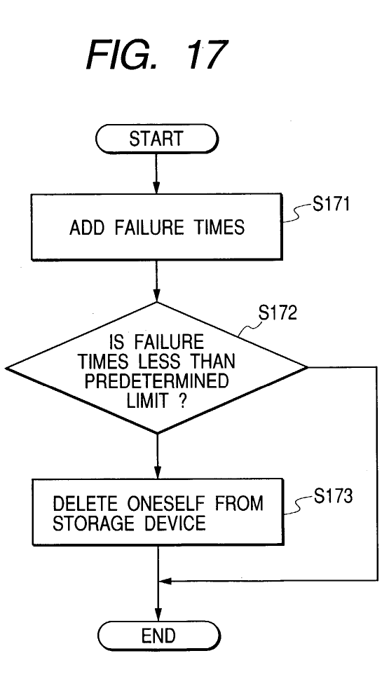

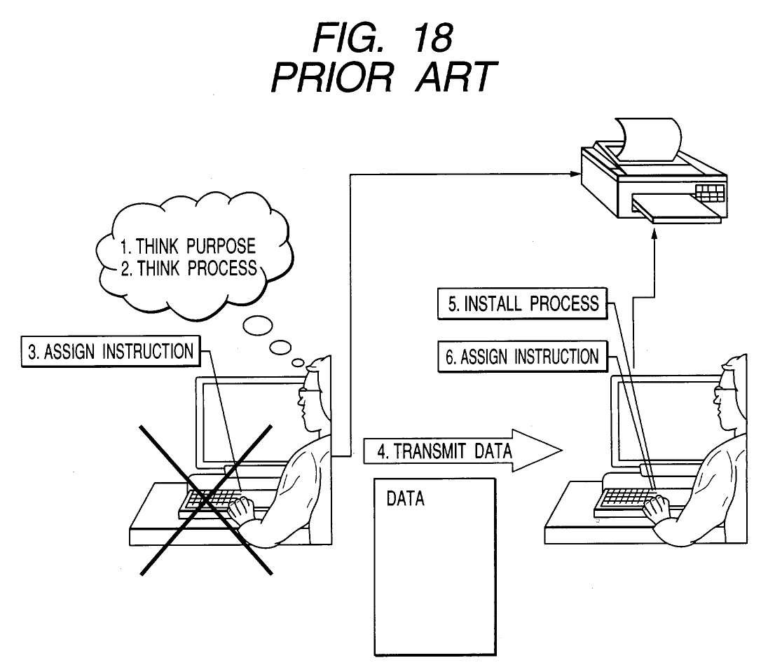

FIG. 17 is a flowchart as an extraction of the characteristic portion with respect to the failure process in step S168 of the print information management process described above. In step S171, a failure count (or failure times) is added to the storage device stored with the failure count. In step S172, it is judged whether or not the failure count of failures accumulated exceeds a predetermined failure count (or a predetermined limit). Processing in step S172 is executed if the failure count is equal to or larger than the predetermined failure count. The failures over the predetermined failure count are conceived unlawful, and therefore the user's own information is deleted from the storage device.

As described above, according to the embodiment 2, the print information is created in such a way that the print information contains the program for managing the print information. Therefore, according to this embodiment 2, in the case of utilizing the print result, the external program is unable to deal with the print information directly, and can acquire and utilize the print information only through the print information management program contained in the print information. This scheme enables the management program to confirm the environment where the displaying and printing are carried out, thereby making it possible to have the print information dealt with only in the environment intended by the user who created the print information. This scheme enables only the user who knows the password to deal with the print information and, in addition, makes it possible to designate a machine capable of dealing with the print information and a date/time thereof. For instance, when creating the print information, the identifying information unique to the machine capable of dealing with the same print information is designated, whereby only the machine having this unique identifying information can deal with the information even if electronically copied. Further, an effective period of the information can be controlled, and it is therefore feasible to make such a designation that the effectiveness of the information expires after an elapse of one month, or that the information will becomes browsable after an elapse of ten years.

Thus, according to the embodiment 2, the attributes important in terms of dealing with the document having a high confidentiality, can be given to the electronically created print information.

<Embodiment 3>

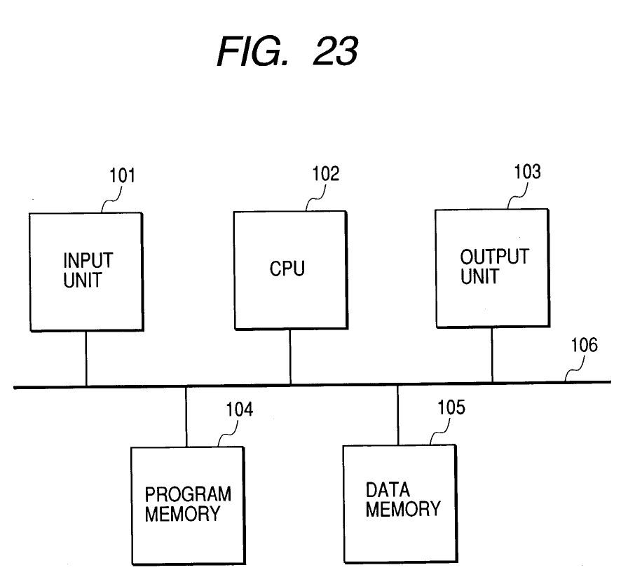

FIG. 23 is a block diagram showing a hardware architecture in one embodiment of the information processing device according to an embodiment 3.

Referring to FIG. 23, an input unit 101 is used for inputting the information. A CPU 102 executes arithmetic operations and logical judgements etc for a variety of processes, and controls respective components connected to an I/O bus 6. An output unit 103 outputs the information.

A program memory 104 is a memory for storing a program for the control by the CPU 102, the program containing processing steps that will be explained in relation to a flowchart. The program memory 104 may be either a ROM or a RAM into which the program is loaded from an external storage device etc.

A data memory 105 is stored with the data generated in the variety of processes and, in addition, with knowledge of a knowledge base that will be mentioned later on. An assumption is that the data memory 105 involves using, e.g., a RAM, however, the knowledge of the knowledge base is loaded in advance of processing from a nonvolatile external storage medium or is referred to each time the necessity may arise.

The bus 106 is utilized for transferring an address signal for giving an instruction to a control subject component of the CPU 102, a control signal for controlling each component and data received and transferred between the respective constructive devices. The embodiment 3 will hereinafter be fully described with reference to the drawings.

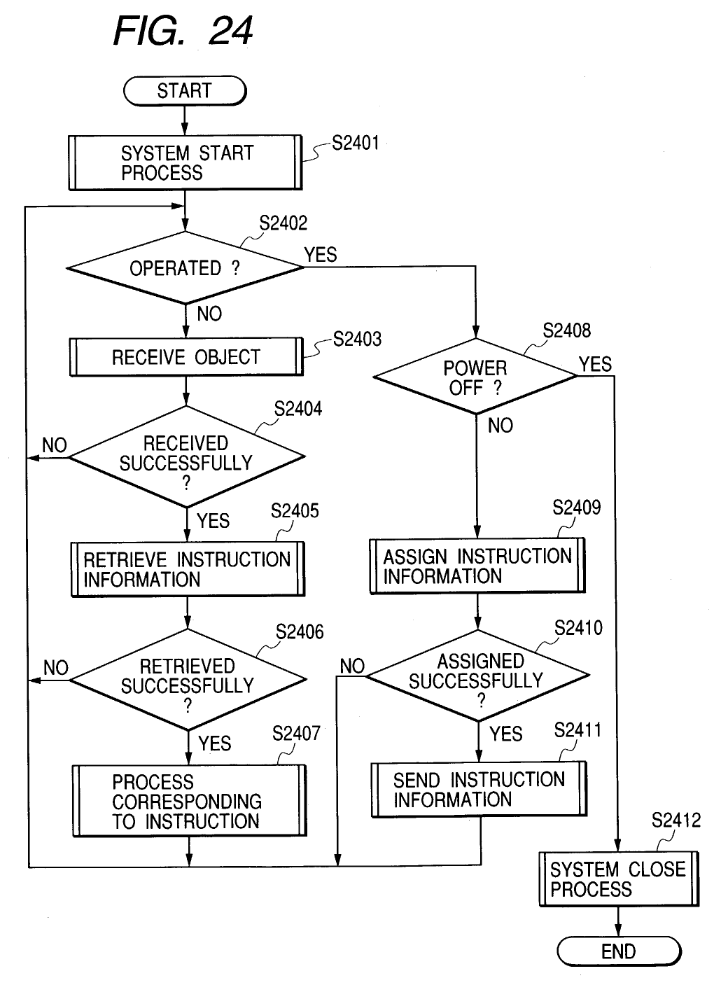

FIG. 24 is a flowchart showing a flow in the whole system in the embodiment 3.

Specifically, when the system is booted, various devices and memories included in the system are initialized in a system start process in step S2401.

Subsequently, if none of user's operations are detected in step S2402, an object transmitted from other device is received in an object receiving process in step S2403. As a result, if it is not judged in next step S2404 that the receipt is successful, the processing loops back to step S2402, wherein the processes are repeated.

When judging in step S2404 that the receipt is successful, instruction information stored in the received object is retrieved in an instruction information retrieval process in next step S2405. As a result, if it is not judged in next step S2406 that the retrieval is successful, the processing again loops back to step S2402, wherein the processes are repeated.

When judging in step S2406 that the retrieval is successful, a process mapping to the instruction information is executed in an instruction corresponding process in next step S2407, and the processing again loops back to step S2402, wherein the processes are repeated.

Subsequently, when detecting in step S2402 that the user performs some operation, the processing proceeds to step S2408, in which it is judged whether this operation instructs power-OFF or not. As a consequence, in the case of judging that the operation instructs the power-OFF, after executing a process of terminating the various devices and memories included in the system, the system is closed in a system close process in step S2412.

If it is not judged in step S2408 that the user's operation instructs the power-OFF, the instruction information corresponding to the operation performed is created in an instruction information assignment process in step S2409. As a result, if it is not judged in next step S2410 that the assignment is successful, the, processing again loops back to step S2402, wherein the processes are repeated.

When judging in step S2410 that the assignment is successful, the object is transmitted to a proper device in an instruction information transmission process in next step S2411, and the processing again loops back to step S2402, in which the processes are repeated.

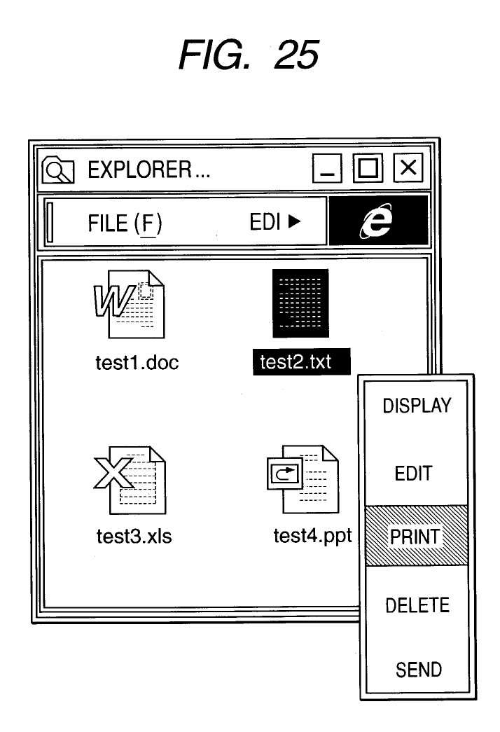

FIG. 25 is a diagram showing one example of the operations performed by the user in the system according to the embodiment 3.

To be specific, FIG. 25 illustrates how a file test2.txt is selected from a file list displayed, an instruction select window is further displayed, and [print] is instructed.

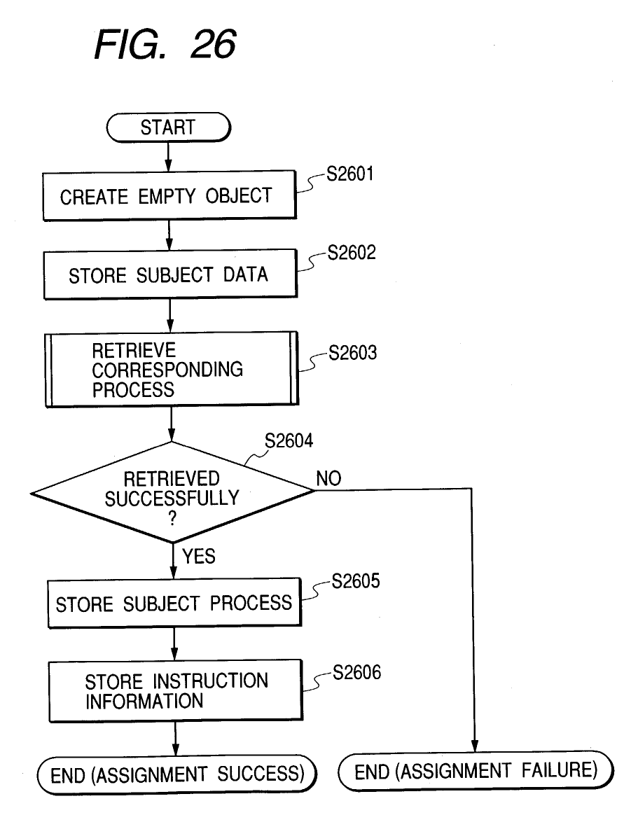

FIG. 26 is a flowchart showing a flow of the instruction information assignment process in step S2409 in the flow of the whole system.

In the instruction information assignment process in the present information processing device, the instruction information corresponding to the operation performed is created and assigned to the object containing the subject data and the subject process.

Specifically, when the instruction information assignment process is booted, a null (empty) object is created in step S2601, and the subject data is stored in this object in subsequent step S2602.

In next step S2603, a process mapping (corresponding) to a type of the data designated by the operation performed and to a type of the instruction, is retrieved by referring to a corresponding process definition table that will be explained later on. As a result, if it is not judged in next step S2604 that the retrieval is successful, the processing ends up with an assignment failure.

When judging in step S2604 that the retrieval is successful, the corresponding process is stored in the object in subsequent step S2605 and, after the instruction information has been stored in the object in next step S2606, the processing terminates with an assignment success.

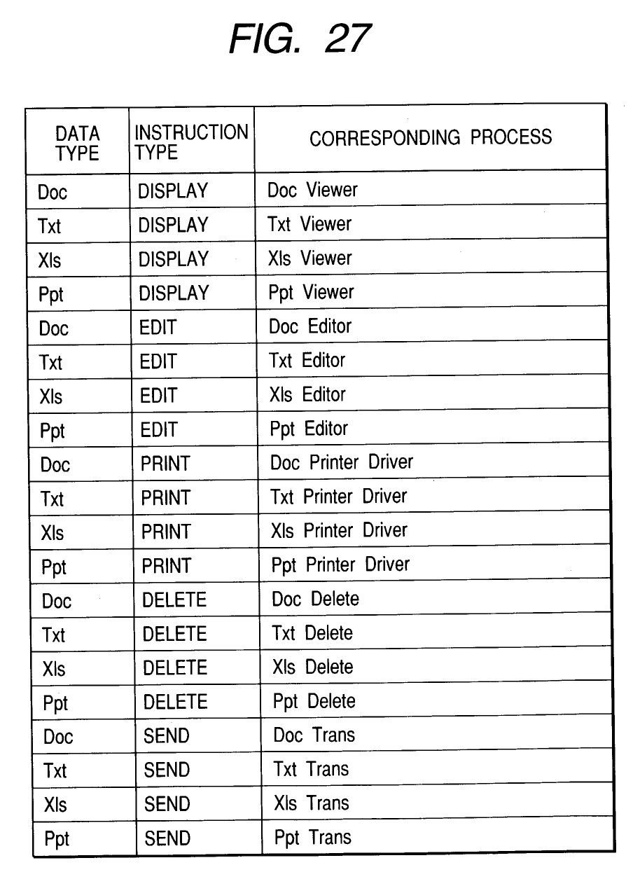

FIG. 27 is a diagram showing, in the instruction information assignment process described above, one example of the corresponding process definition table that is referred to in the corresponding process retrieval process in step S2603.

The corresponding process definition table in the present information processing device contains definitions of a type of the data designated by the operation performed and of a process mapping to the category of the instruction.

For instance, in the case of the example shown in FIG. 25, “Txt Printer Driver” mapping to a type “Txt” of the file “test2.txt” and to an instruction category “print”, is defined as a corresponding process.

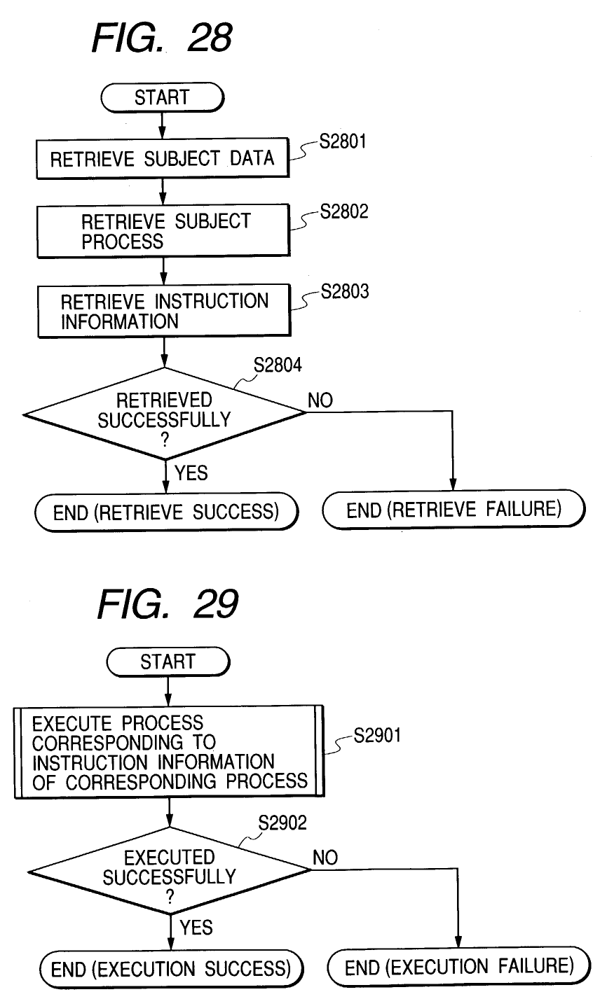

FIG. 28 is a flowchart showing a flow of the instruction information retrieval process in step S2405 in the flow of the whole system.

The instruction information retrieval process in the present information processing device, retrieves the subject data stored in the received object, the corresponding process and the instruction information.

Specifically, the instruction information retrieval process, when booted, retrieves the subject data stored in the object received in step S2801, the corresponding process in next step S2802, and the instruction information in next step S2803. As a result, in the case of judging in next step S2804 that the retrieval is successful, the processing ends up with the retrieval success. Whereas if it is judged that the retrieval falls into a failure, the processing terminates with a retrieval failure.

FIG. 29 is a flowchart showing a flow of the instruction corresponding process in step S2407 in the flow of the whole system.

In the instruction corresponding process in the present processing device, a process mapping to the instruction information is executed.

To be specific, when the instruction corresponding process is booted, an instruction information corresponding process execution process in the corresponding process in step S2901 executes a process mapping to the instruction information in the processes held by the object received. As a consequence, when judging in next step S2902 that the execution is successful, the processing ends up with an execution success. Whereas if it is judged that the execution falls into a failure, the processing terminates with an execution failure.

Herein, the flow in FIG. 21 will be specifically explained with reference to the drawings illustrated so far.

FIG. 21 shows how the user operates the machine in order to attain some purpose. Specifically, the following steps are taken.

1. Think of a purpose “transfer the information to Mr. A”.

2. The user becomes aware that the information must be converted into a humanly-operable physical format such as being visually or audibly perceived in order to transfer the information, and thinks of commanding the machine to execute a process “print the information”.

3. The user boots an application corresponding to the print process and assigns a print instruction by performing the print operation.

4. The print cannot be effected due to a trouble of the operating machine, and hence a file to be printed is transferred to other machine.

The prior arts further require operating the machine to which the file has been transferred, however, the embodiment 3 does not require.

5. A printer driver is not installed into the transfer destination machine, and therefore a program necessary for installing it is obtained, and the installation is carried out.

6. The operation in the step 3 is conducted in steps matching with the transfer destination machine.

This implies that the instruction assignment in step 3 leads to a creation of the object holding the subject data, the corresponding process and the instruction information through the instruction information assignment process in step S2409 in FIG. 24, and therefore a necessity of installing the corresponding process and re-assigning the instruction is eliminated by transferring and receiving the above object even if unable to print due to some cause.

<Embodiment 4>

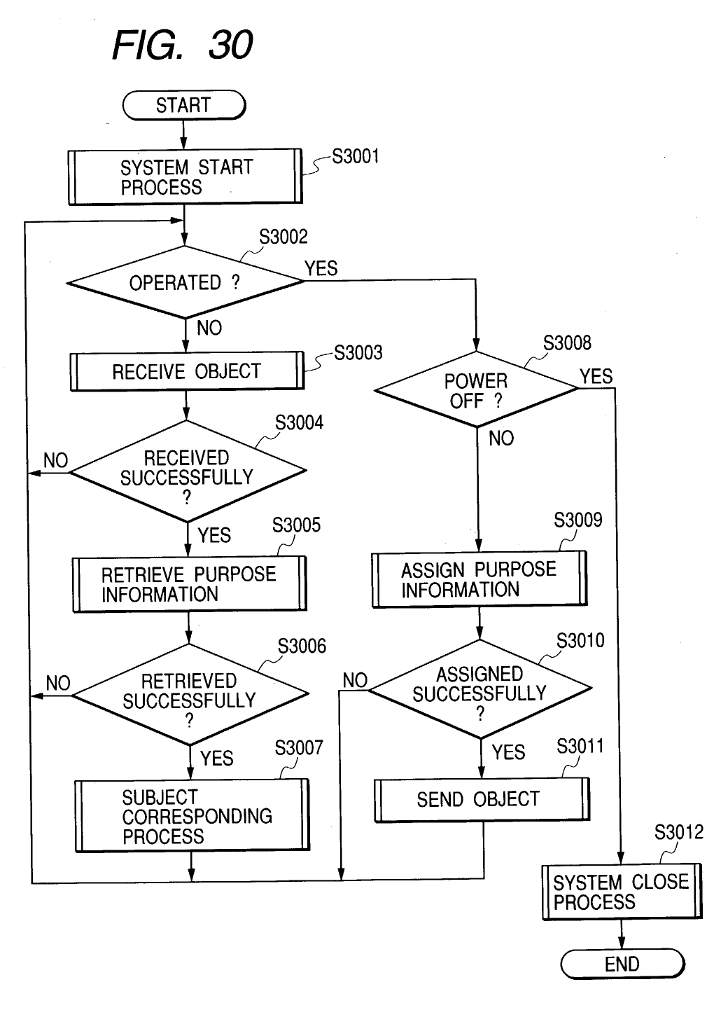

FIG. 30 is a flowchart showing a flow of the whole system in an embodiment 4.

To be specific, upon a start-up of the system, the variety of devices and the memories included in the system are initialized in a system start process in step S3001.

Subsequently, if none of user's operations are detected in step S3002, an object transmitted from other device is received in an object receiving process in step S3003. As a result, if it is not judged in next step S3004 that the receipt is successful, the processing loops back to step S3002, wherein the processes are repeated.

When judging in step S3004 that the receipt is successful, purpose information stored in the received object is retrieved in a purpose information retrieval process in next step S3005. As a result, if it is not judged in next step S3006 that the retrieval is successful, the processing again loops back to step S3002, wherein the processes are repeated.

When judging in step S3006 that the retrieval is successful, a process corresponding to the purpose information is executed in a purpose corresponding process in next step S3007, and the processing again loops back to step S3002, wherein the processes are repeated.

Subsequently, when detecting in step S3002 that the user performs some operation, the processing proceeds to step S3008, in which it is judged whether this operation instructs power-OFF or not. As a consequence, in the case of judging that the operation instructs the power-OFF, after executing a process of terminating the various devices and memories included in the system, the system is closed in a system close process in step S3012.

If it is not judged in step S3008 that the user's operation instructs the power-OFF, purpose instruction information corresponding to the operation performed is created in a purpose information assignment process in step S3009. As a result, if it is not judged in next step S3010 that the assignment is successful, the processing again loops back to step S3002, wherein the processes are repeated.

When judging in step S3010 that the assignment is successful, the object is transmitted to a proper device in a purpose information transmission process in next step S3011, and the processing again loops back to step S3002, in which the processes are repeated.

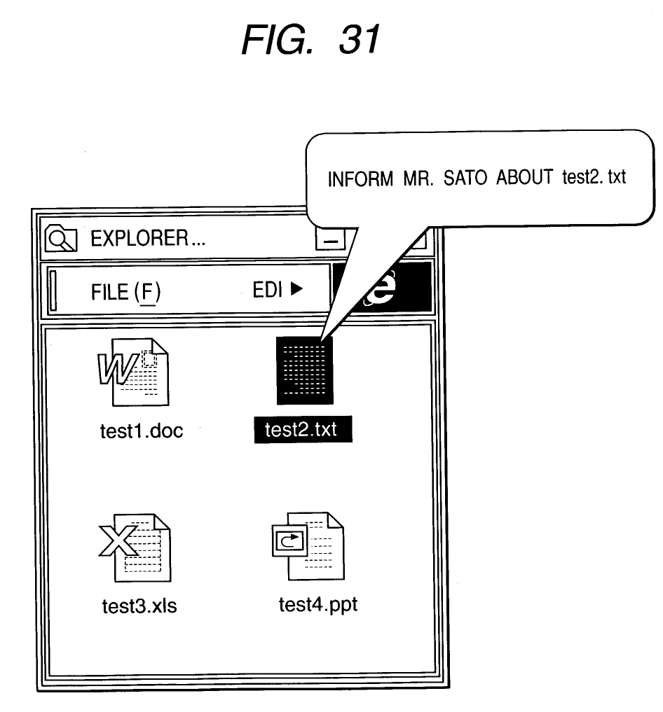

FIG. 31 is a diagram showing one example of the operations performed by the user in the system according to the embodiment 4.

To be specific, FIG. 31 illustrates how a file test2.txt is selected from a file list displayed, and a purpose “transfer the content of test2.txt to Mr. Sato” in voice.

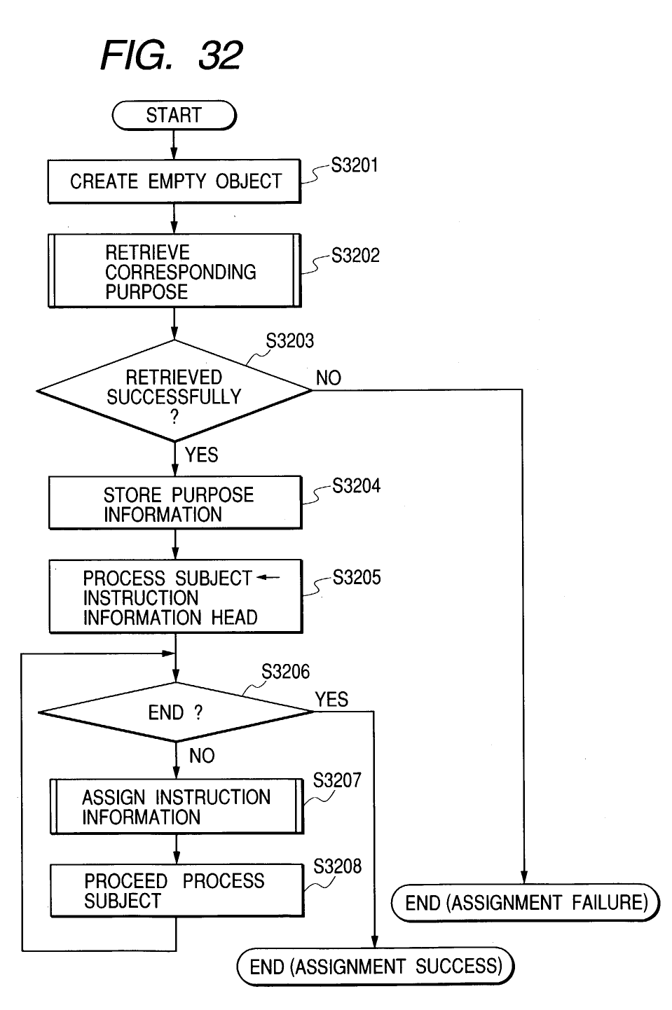

FIG. 32 is a flowchart showing a flow of the purpose information assignment process in step S3009 in the flow of the whole system.

In the purpose information assignment process in the present information processing device, the purpose information corresponding to the operation performed. is created and assigned to the object containing the subject data, the subject process and the instruction information.

Specifically, when the purpose information assignment process is booted, a null object is created in step S3201, and a purpose corresponding to the operation performed is retrieved in a corresponding purpose retrieval process in subsequent step S3202 by referring to a corresponding purpose definition table that will be explained later on.

As a result, if it is not judged in next step S3203 that the retrieval is successful, the processing ends up with an assignment failure.

When judging in step S3203 that the retrieval is successful, after the purpose information has been stored in the object in subsequent step S3204, a processing subject is initialized in next step S3205 at the head of an instruction list corresponding to the purpose described above, which is defined in a purpose corresponding instruction definition table that will be explained later on.

When judging in next step S3206 that the processing subject is not finished (end), a corresponding piece of instruction information is created and assigned to an obtained containing the subject data and the subject process in an instruction information assignment process in subsequent step S3207, the processing subject is advanced in next step S3208, and the processing again loops back to step S3206, wherein the processes are repeated.

When judging in step S3206 that the processing subject is finished, it is judged that all pieces of instruction information corresponding to the purpose be assigned, and the processing ends up with an assignment success.

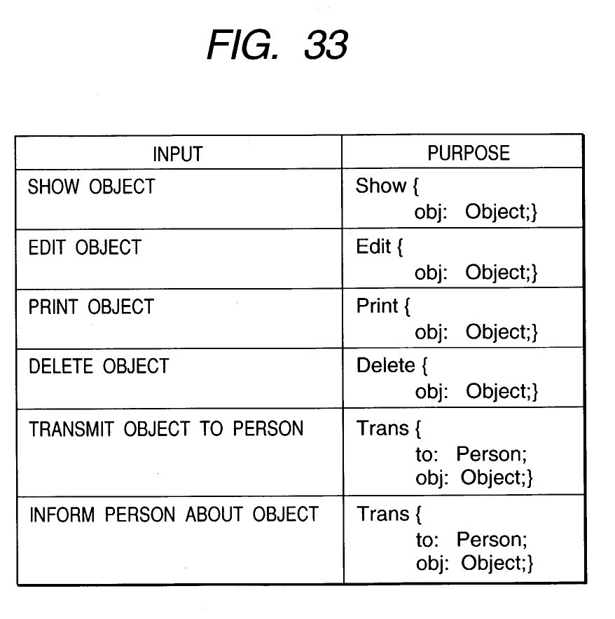

FIG. 33 is a diagram showing, in the purpose information assignment process described above, one example of the corresponding purpose definition table that is referred to in the corresponding purpose retrieval process in step S3202.

The corresponding purpose definition table in the present information processing device contains definitions of the purposes corresponding to the operations performed.

For instance, in the case of the example shown in FIG. 31, there is defined, as a corresponding purpose, “Trans{to:Person;obj:Object;}” mapping to an input pattern “Transfer Object to Person” corresponding to such an operation that the user selects the file test2.txt and inputs “transfer the content of test2.txt to Mr. Sato” in voice.

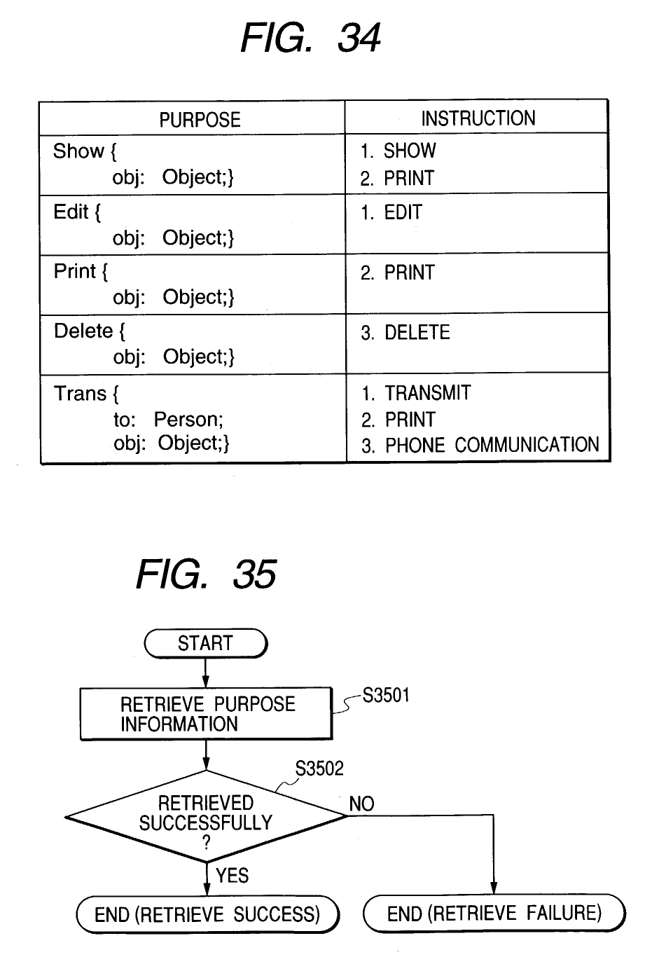

FIG. 34 is a diagram showing, in the purpose information assignment process described above, one example of a purpose corresponding instruction definition table that is referred to by way of a processing subject in step S3205.

The purpose corresponding instruction definition table in the present information processing device, defines an instruction list in which the instructions mapping to the purposes are arranged according to the priority.

For example, in the case of the example shown in FIG. 31, the above corresponding purpose definition table defines, as a corresponding instruction list, the instructions such as “1. Transmit, 2. Print, 3. Phone communication” mapping to the purpose “Trans{to:Person;obj:Object;}” retrieved.

FIG. 35 is a flowchart showing a flow of the purpose information retrieval process in step S3005 in the flow of the whole system.

In the purpose information retrieval process in the present information processing device, the purpose information stored in the object received is retrieved.

Specifically, when the purpose information retrieval process is booted, the purpose information stored in the object received is retrieved in step S3501. As a result, when judging in next step S3502 that the retrieval is successful, the processing terminates with a retrieval success. Whereas if it is judged that the retrieval falls into a failure, the processing ends up with a retrieval failure.

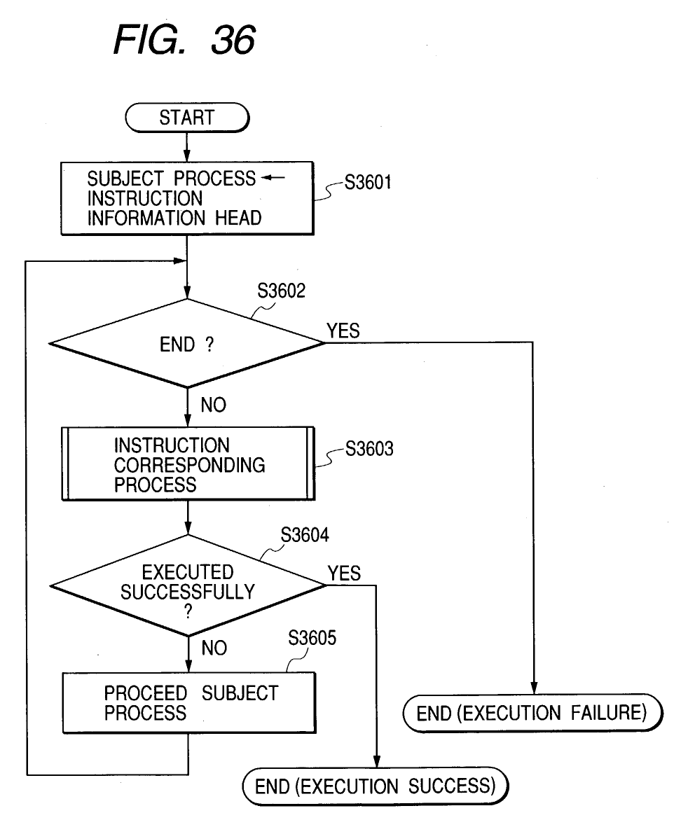

FIG. 36 is a flowchart showing a flow of the purpose corresponding process in step S3007 in the flow of the whole system.

In the purpose corresponding process in the present information processing device, a process corresponding to the purpose information is executed.

To be specific, when the purpose corresponding process is booted, the processing subject is initialized in step S3601 at the head of an instruction information list held by the object received.

When judging in next step S3602 that the processing subject is not finished (end), a process mapping to the instruction information is executed in the instruction corresponding process in subsequent step S3603. As a result, when judging in next step S3604 that the execution is successful, the processing terminates with an execution success.

Whereas if it is not judged in step S3604 that the execution is successful, the processing subject advances to the next instruction information, and the processing again loops back to step S3602, wherein the processes are repeated.

When judging in step S3602 that the processing subject is finished, it is judged that all pieces of instruction information corresponding to the purpose fail to be executed, and the processing ends up with the execution failure.

Herein, the flow in FIG. 22 will be specifically explained with reference to the drawings illustrated thus far.

FIG. 22 shows how the user operates the machine in order to attain some purpose. Specifically, the following steps are taken.

1. Think of a purpose of “transferring the information to Mr. A”, and gives an instruction in voice.

2. The user becomes aware that the information must be converted into a humanly-operable physical format such as being visually or audibly perceived in order to transfer the information, and thinks of commanding the machine to execute a process “print the information”.

3. The user boots an application corresponding to the print process and assigns a print instruction by performing the print operation.

4. The print cannot be effected due to a trouble of the operating machine, and hence a file to be printed is transferred to other machine.

5. A printer driver is not installed into the transfer destination machine, and therefore a program necessary for installing is obtained, and the installation is carried out.

6. The operation in the step 3 is conducted in steps matching with the transfer destination machine.

This implies that the purpose assignment in step 1 leads to a creation of the object holding the subject data, the corresponding process, the instruction information and the purpose information through the purpose information assignment process in step S3009 in FIG. 30, the user therefore thinks of the process corresponding to the purpose and comes to have no necessity of determining a proper process, and a necessity of installing the corresponding process and re-assigning the purpose is eliminated by transferring and receiving the above object even if unable to print due to some cause.

Specifically, in the purpose information assignment process in step S3009 in FIG. 30, an object holding pieces of instruction information such as “1. Transmit, 2. Print, 3. Phone Communication” mapping to the purpose “Trans{to:Person;obj:Object;}” corresponding to the input operation, is created and transmitted in step S3011.

Consequently, in the machine receiving this object, the above purpose is retrieved in the purpose information retrieval process in step S3005, and the processes mapping to the pieces of instruction information given above are tried in sequence in the purpose corresponding process in step S3007.

For example, to begin with, a transmission process mapping to instruction information “1. Transmit” is tried. If the execution thereof falls into a failure for such a reason that a transmitting destination has no receiving means and so forth, however, a print process mapping to the next instruction information “2. Print” is tried. Even by this try, the execution thereof results in a failure due to a reason such as a fault of the print-instructed printer, a phone communication process mapping to the next instruction information “3. Phone Communication” is tried. Then, a phone call is given to the transmission destination, a content of the transmission subject is transferred by means of voice synthesization and so on, and eventually it is judged that the execution is successful, thereby finishing the processing.

<Embodiment 5>

The purpose corresponding process in the embodiment 4 has tried the execution of only the instruction information designated by the purpose information assignment process. The discussion in this embodiment 5, however, will be focused on a method of trying to attain the purpose even if the execution for none of the instructions results in a failure as a result of executing based on the instruction information stored in the object received.

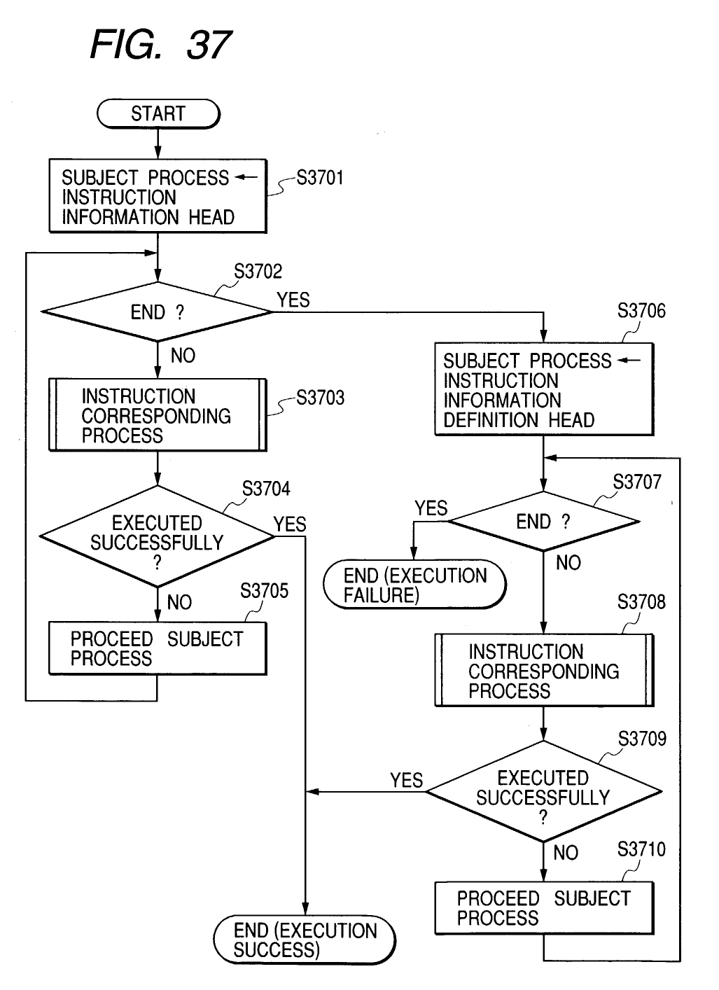

FIG. 37 is a flowchart showing a flow of the purpose corresponding process in step S3007 in the flow of the whole system.

In the purpose corresponding process in the present information processing device, the process mapping to the purpose information is executed.

To be specific, when the purpose corresponding process is booted, the processing subject is initialized in step S3701 at the head of the instruction information list held by the object received.

When judging in next step S3702 that the processing subject is not finished (end), a process mapping to the instruction information is executed in the instruction corresponding process in subsequent step S3703. As a result, when judging in next step S3704 that the execution is successful, the processing terminates with an execution success.

Whereas if it is not judged in step S3704 that the execution is successful, the processing subject advances to the next instruction information, and the processing again loops back to step S3702, wherein the processes are repeated.

When judging in step S3702 that the processing subject is finished, it is judged that all pieces of instruction information corresponding to the purpose designated by the object received fail to be executed, and the processing proceeds to step S3706.

The processing subject is initialized in step S3706 at the head of the list of instruction information mapping to the above purpose, which is defined in the purpose corresponding instruction definition table.

When judging in next step S3707 that the processing subject is not finished (end), a process mapping to the instruction information is executed in the instruction corresponding process in subsequent step S3708. As a result, when judging in next step S3709 that the execution is successful, the processing terminates with an execution success.

Whereas if it is not judged in step S3709 that the execution is successful, the processing subject advances to the next instruction information, and the processing again loops back to step S3707, wherein the processes are repeated.

When judging in step S3707 that the processing subject is finished, it is judged that the executions of all pieces of instruction information corresponding to the purpose that are designated by the list of instructions, mapping to the purpose, defined in the purpose corresponding instruction definition table described above fall into a failure, and the processing ends up with an execution failure.

With the processes executed above, as a result of executing based on the instruction information stored in the object received, even if the execution of any one of the instructions results in the failure, the execution can be tried by referring to the list of instructions mapping to the above purpose that are defined in the above purpose corresponding instruction definition table.

This scheme, in an extreme example, assigns only the purpose to the object, whereby this purpose is judged on the receiving side, and the execution can be done as the occasion demands.

Further, only the specific instruction may be assigned to the object, and, only when this instruction results in the failure on the receiving side, the instruction can be retrieved and executed as it gets back to the original purpose.

Namely, the method exemplified in this embodiment enables a more flexible high operation to be performed and can enhance a possibility that the user attains the purpose.

According to the embodiments discussed so far, the instruction information showing the process that should be executed is assigned to the information serving as the subject and this transmitted, the instruction information is retrieved from the received information, and the process corresponding to the retrieved instruction information is executed, whereby it is possible to eliminate the necessity of re-assigning the instruction even to a different machine and to remarkably relieve the load on the user.

Moreover, the instruction may be assigned to only the machine that the user is well accustomed to use, and hence the user has no necessity of operating the machine that the user feels it difficult to use.

Note that the present invention may be applied to a system configured by a plurality of devices (e.g., a computer main body, an interface device, a display etc) and to an apparatus constructed of a single device within a range in which the functions in the embodiments described above can be actualized.

Further, the range of the invention of the present application also includes an architecture embodied in such a way that the computer in the apparatus or the system connected to a variety of devices is, for the purpose of operating the variety of devices so as to actualize the functions in the embodiments discussed above, supplied with program codes of the software for actualizing the functions in the embodiments discussed above, and the variety of devices are operated by the computer (or a CPU and an MPU) of the system or the apparatus in accordance with the supplied program codes. Further, in this case, the program codes themselves, which are read from a storage medium, actualize the function sin the embodiments explained above, wherein the present invention is configured by the program codes themselves and a means, e.g., a storage medium stored with these program codes, for supplying the computer with the program codes.

The storage medium for supplying the program codes may involve the use of, for example, a floppy disk, a hard disk, an optical disk, a magneto-optic disk, a CD-ROM, a CD-R, a magnetic tape, a nonvolatile memory card, a ROM and so on.

Moreover, the program codes described above are, as a matter of course, included in the range of the invention of the present application in a case where the functions in the embodiments discussed above are actualized in cooperation with an OS (Operating System) or other application software running on the computer on the basis of instructions of the program codes as well as a case where the functions in the embodiments discussed above are actualized by executing the program codes read by the computer.

Furthermore, there is, as a matter of course, included a case where the program codes read from the storage medium are written to a memory provided in an extension board installed into the computer or in an extension unit connected to the computer, and thereafter a CPU etc provided in the extension board or in the extension unit executes a part or the whole of actual processes on the basis of the instructions of the program codes, whereby the functions in the embodiments discussed above are actualized by this processing.

In the case of applying the invention of the present application to the storage medium described above, the storage medium may be stored with the program codes corresponding to the flowcharts explained above.

Although the present invention has been described in its preferred from with a certain degree of particularity, many apparently widely different embodiments of the invention can be made without departing from the spirit and the scope thereof. It is to be understood that the invention is not limited to the specific embodiments thereof except as defined in the appended claims.

What is claimed is:

1. An information processing device comprising:
instruction information assigning means for assigning instruction information showing a process that should be executed, to process subject information;
transmitting means for transmitting the process subject information assigned the instruction information;
receiving means for receiving the process subject information;
instruction information retrieving means for retrieving the instruction information from the processing subject information received; and
process executing means for executing a process corresponding to the retrieved instruction information upon the processing subject information received.

2. An information processing device according to claim 1, wherein said instruction information assigning means is stored with the processing subject information, the corresponding process and the instruction information in a way that makes these elements related to each other.

3. An information processing device according to claim 1, wherein said instruction information assigning means includes corresponding process determining means for determining the corresponding process based on a data type of the processing subject information and a type of the instruction.

4. An information processing device according to claim 3, wherein said corresponding process determining means determines the corresponding process by referring to a corresponding process definition table that defines the process in a way that makes it corresponding to the data type of the processing subject information and to the type of the instruction.

5. An information processing device comprising:
purpose information assigning means for assigning purpose information showing a purpose of a process to processing subject information;
transmitting means for transmitting the processing subject information assigned the purpose information;
receiving means for receiving the processing subject information;
purpose information retrieving means for retrieving the purpose information from the processing subject information received; and
process executing means for executing a process corresponding to the retrieved purpose information upon the processing subject information received.

6. An information processing device according to claim 5, wherein said purpose information assigning means is stored with the processing subject information, the corresponding process, the instruction information and the purpose information in a way that makes these elements related to each other.

7. An information processing device according to claim 6, wherein said purpose information assigning means can be stored with two or more pieces of processing subject information, the corresponding process and the instruction information in a way that makes these elements to one piece of purpose information.

8. An information processing device according to claim 5, wherein said purpose information assigning means includes purpose determining means for determining a corresponding purpose from an input operation.

9. An information processing device according to claim 8, wherein said purpose determining means determines the corresponding purpose by referring to a corresponding purpose definition table that defines the purpose corresponding to an input operation pattern.

10. An information processing device according to claim 8, wherein said purpose information assigning means includes instruction information retrieving means for retrieving the instruction information corresponding to the purpose determined by said purpose determining means.

11. An information processing device according to claim 10, wherein said instruction information retrieving means retrieves the corresponding instruction information by referring to a purpose corresponding instruction definition table that defines the instruction information corresponding to the purpose.

12. An information processing device according to claim 10, wherein said instruction information retrieving means can retrieve one or more pieces of instruction information corresponding to the purpose.

13. An information processing device according to claim 12, wherein said process executing means executes the process corresponding all pieces of retrieved instruction information till even one process becomes successful.

14. An information processing device according to claim 13, wherein said process executing means, if the process corresponding to all pieces of retrieved instruction information falls into a failure, executes the process corresponding to the all pieces of instruction information retrieved from the retrieved purpose information till even one process becomes successful.

15. An information processing method executed by a first device and a second device, comprising the steps of:
assigning instruction information showing a process that should be executed to processing subject information by said first device;
transmitting the processing subject information assigned the instruction information to said second device by said first device;
receiving the processing subject information by said second device;
retrieving the instruction information from the received processing subject information by said second device; and
executing the process corresponding to the retrieved instruction information upon the received processing subject information by said second device.

16. An information processing method executed by a first device and a second device, comprising the steps of:
assigning purpose information showing a purpose of a process to processing subject information by said first device;
transmitting the processing subject information assigned the purpose information to said second device by said first device;
receiving the processing subject information by said second device;
retrieving the purpose information from the received processing subject information by said second device; and
executing a process corresponding to the retrieved purpose information upon the received processing subject information by said second device.
